(19) United States
(12) Patent Application Publication
(10) Pub. No.: US 2008/0185408 A1
(43) Pub. Date: Aug. 7, 2008

(54) Beverage Pack

(76) Inventor: Stephen Andrew Craig James, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/913,865

(22) PCT Filed: May 26, 2006
(86) PCT No.: PCT/NZ06/00131

§ 371 Date: Nov. 28, 2007

(30) Foreign Application Priority Data
May 27, 2005 (NZ) 540431
Dec. 2, 2005 (NZ) 543967

(51) Int. Cl. A45F 3/20; A45F 3/02; A45F 3/04; B29C 69/00; B31B 49/00; A45F 3/16

(52) U.S. Cl. 224/148.2; 29/592; 493/343; 156/256

(57) ABSTRACT

The beverage pack comprises a bladder (1) with at least one strap (T) that is integral to the pack. The pack is manufactured so that it is highly durable, strong and minimises plastic wastage, making the pack durable, cost effective and beneficial to the environment. In some forms the pack is be disposable. The pack preferably includes an area of insulation (7), such as bubble type wrap or any other appropriate insulating material, on at least part of it. The pack may also include a reflective panel, such as silver type plastic, on its front panel to keep the beverage within the pack cold and to reflect sunlight. The pack includes a non-toxic drinking hose (4) that is sealed within pack. The integrated strap enables the pack to be easily manufactured to keep it durable and strong to be carried by a person and taken anywhere.

### BACKGROUND OF INVENTION

1. Field of the Invention

The present invention relates to a disposable beverage pack for the storage and carrying of liquids, particularly adapted to be worn on the back of an individual.

2. Summary of the Prior Art

Portable wearable beverage packs have become beneficial to many sports enthusiasts especially cyclists and runners to enable them to re-hydrate when on the move.

United States Patent Application Number 2004/0065703 A1 of Randy A. Bellucci discloses an athletic hydration pack with bladder. In one embodiment a belt is attached to the bladder. The bladder is refillable via a cap that retains a drinking hose that is separate from the bladder. A gel pack is also disclosed to keep the bladder cool and prevent dilution of the contents of the bladder.

United States Patent Application Number 2003/0156766 of Roland E. Stefandl discloses a beverage container pouch. The pouch has a straw internally embedded in the pouch to keep it hygienic.

Bladders placed inside backpacks or the like are known, such as those disclosed in U.S. Pat. No. 5,060,833, U.S. Pat. No. 5,427,290, U.S. Pat. No. 4,948,023 and U.S. Pat. No. 5,358,142.

In some situations it is inconvenient to carry a bottle or full back pack, for example, whilst dancing at a night club, attending a concert or other event, or merely walking or trelding. With many packs or bottles there is a danger of the beverage contents being tampered with or being made unhygienic. Furthermore, some portable reuseable packs are expensive to buy and not suitable for one off use.

### DISCLOSURE OF THE INVENTION

It is an object of the present invention to provide a beverage pack which goes some way to overcoming the abovementioned disadvantages or which at least provides the public or industry with a useful choice.

Accordingly in a first aspect the present invention consists in a beverage pack comprising:
a pliable bladder capable of storage of a liquid beverage,
at least one strap integral with said bladder,
a hose capable of accessing said liquid beverage in said bladder and being sealed with said bladder.
Preferably said hose is fixed substantially along its length to said bladder.
Preferably said hose is plastic welded to said bladder.
Preferably said bladder has at least an area of insulation at least on one side of said bladder.
Preferably said bladder has a reflective area on at least one area of said bladder.
Preferably said insulation is a layer of bubble wrap attached to said bladder.
Preferably said reflective area is a reflective panel made from a reflective material, such as a silver plastic sheet or the like.
Preferably said reflective panel is disposed on the front of said bladder.
Preferably said bladder includes an integral aperture and a closure over said aperture to enable filling of said bladder.
In a second aspect the present invention consists in a method of making a beverage pack including the steps of:
cutting out a bladder and at least one strap from a single folded rectangle of plastic,
welding a substantially rectangular bladder and at least one elongated strap,
folding said strap into a correct position to enable extending of said strap from said bladder over at least one of a users shoulder in use, and
welding said strap in said position.
Preferably said method includes the step of welding a layer of insulation to said bladder.
Preferably said method includes the step of welding a layer of reflective material to said bladder.
Preferably said method includes the steps of welding a hose connector to said bladder and imbedding and welding a hose along the side of said bladder.
Preferably said method includes imbedding a strap adjuster in said strap to allow the length of said strap to be adjusted.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### BRIEF DESCRIPTION OF THE DRAWINGS

Preferred forms of the present invention will now be described with reference to the accompanying drawings.

FIG. 1 is a front view of a first form of a pack of the present invention, where the pack has two straps.

FIG. 2 is a side view of the pack of FIG. 1.

FIG. 3 is an illustration of the stencil that may be cut out to form the pack of FIG. 1.

FIG. 4 is a front view of a second form of a pack of the present invention, where the pack has only one strap.

FIG. 5 is a side view of the pack of FIG. 4.

FIG. 6 is an illustration of the stencil that may be cut out to form the pack of FIG. 4.

FIG. 7 is a front view of a third form of a pack of the present invention, where the pack has an aperture and cap to enable the pack to be refilled.

FIG. 8 is a side view of the pack of FIG. 7.

FIG. 9 is a front view of a fourth form of a pack of the present invention where the pack has only one strap and has an aperture and cap to enable the pack to be refilled.

FIG. 10 is an illustration of a stencil that may be cut out to form a pack of a fifth form.

FIG. 11 is an illustration of a stencil that may be cut out to form a pack of a sixth form, where the pack has a sealable opening.

### DETAILED DESCRIPTION OF THE PREFERRED EMBODIMENTS

The present invention is a portable, disposable beverage pack. The pack is to be used for hands free convenience and is a hygienic way to transport, move or carry a volume of beverage when the user is performing a range of activities, from working, dancing to mountain biking to watching sport or when at a concert or event.

The pack comprises a bladder with at least one strap that is integral to the pack. The pack is manufactured so that it is highly durable, strong and minimises plastic wastage, making the pack durable, cost effective and beneficial to the environment. The pack is preferably disposable and preferably includes an area of insulation, such as bubble wrap or any other appropriate insulating material, on at least part of it. The pack may also include a reflective panel, such as a silver type plastic, on its front panel to keep the beverage within the pack cold and to reflect sunlight. The pack includes a non-toxic drinking hose that is sealed within the pack. The integrated strap(s) enable the pack to be easily manufactured to keep it durable and strong to be carried by a person and taken anywhere.

In a first form of the pack of the present invention, the pack is disposable and non-refillable. In this form the disposable and non-refillable aspects ensure the contents of the pack remain hygienic to the consumer, and safe from tampering and spiking.

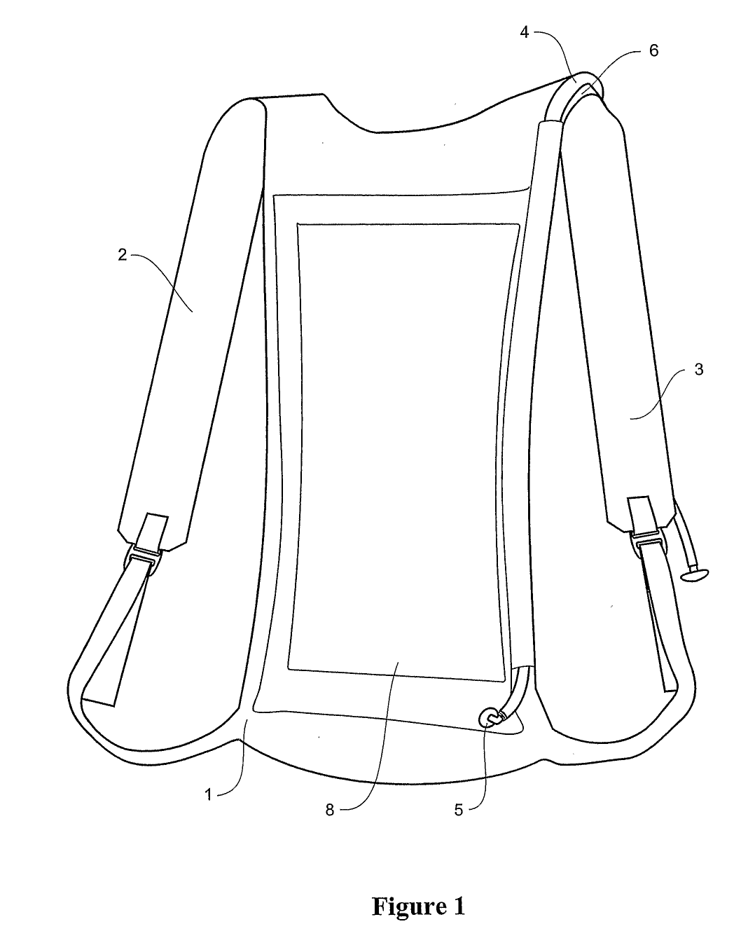

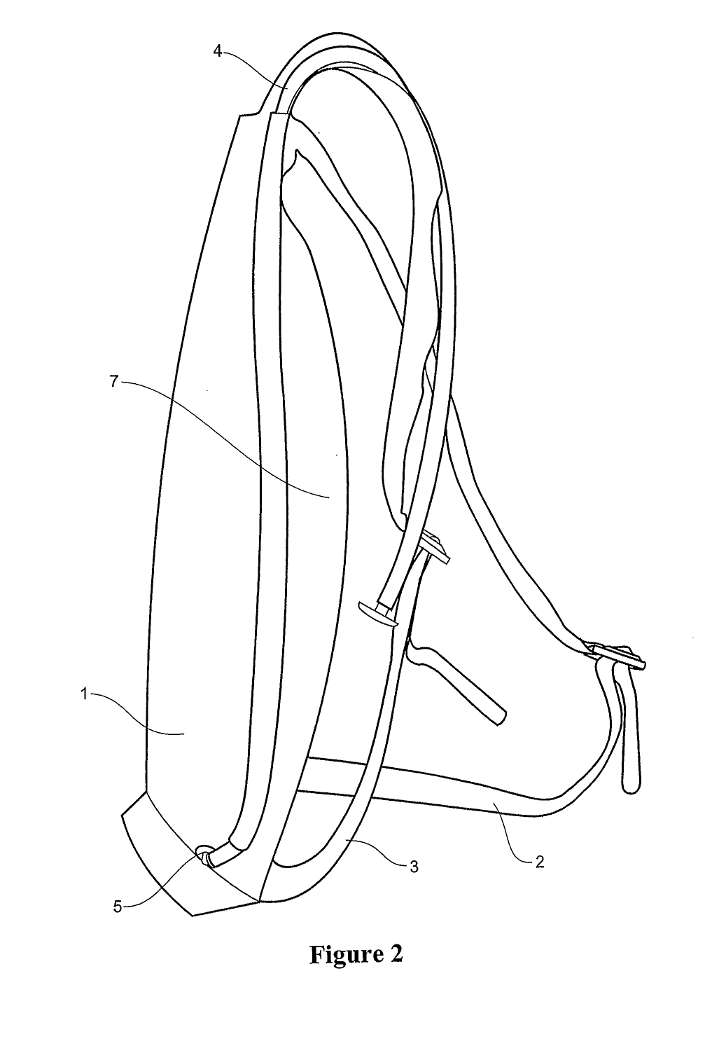

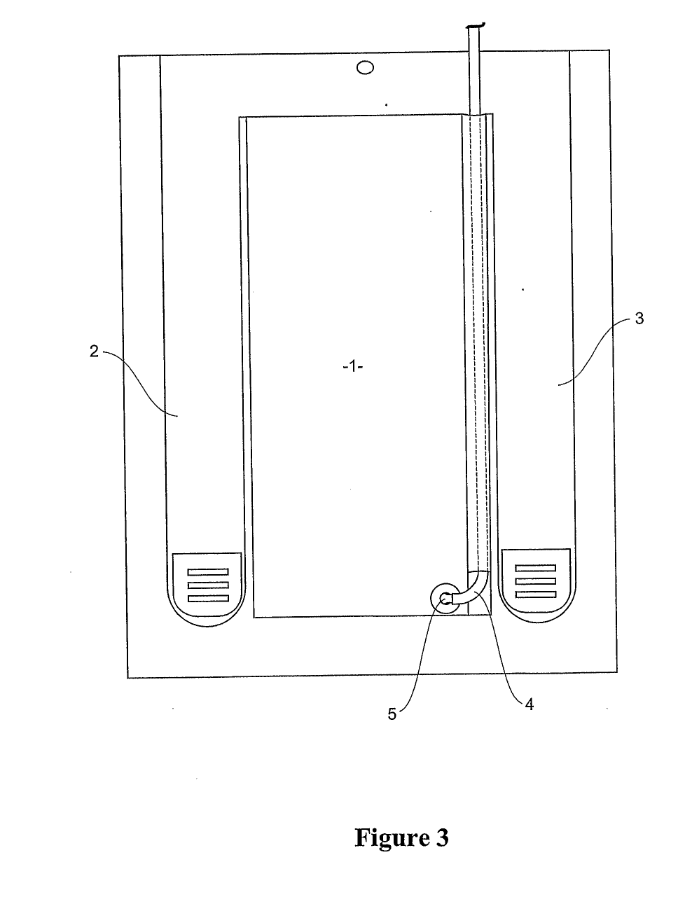

FIGS. 1 to 3 shows a first form of the pack of the present invention. The pack is a bladder 1 made from a thin, preferably strong and food quality plastics material, such as a non-toxic food safe polypropylene ply, polyester ply or other appropriate plastics material. The plastic making up the bladder 1 is preferably biodegradable.

Integral with the bladder 1 are straps 2, 3. Preferably the straps 2, 3 are made from the same material as the bladder. In this first form there are two straps 2, 3 that in use extend over the shoulders of a user and hold the pack securely on the user's back. During the manufacturing process the bladder is filled with a beverage, such as sports water or the like. A hose 4 extends from the bottom edge of the bladder 1 through a sealed envelope 5, along the bladder's length and extends to the top 6 of one of the straps 3.

The drinking hose 4 is attached and enclosed along a substantial part of the packs length within or on the bladder 1 of the pack. The drinking hose 4 is preferably embedded in the plastic making up the bladder 1, so the hose is snug against the pack. This reduces the amount of hose used and also helps maintain the overall form and shape of the pack. Furthermore, embedding the hose in the bladder prevents the hose from being pulled out of the bladder and tampered with and reduces the chance of accidental damage to the sealing arrangement of the hose connector and/or bladder. In the preferred manufacture of the pack of the present invention, when the bladder is welded together the hose is welded into the bladder.

At the end of the drinking hose 4 there is a mouthpiece (not shown) that consists of a small flap valve that acts as a non-return valve. These types of non-return valves are well known in the art and any appropriate valve of this type could be used. In the preferred embodiment of the pack of the present invention the end of the hose 4 would be fitted with a reusable plastic protective cover for hygiene purposes.

The pack of the present invention may also have an insulating layer 7. The insulating layer is preferably adhered, die cut and melted, or welded on the back panel of the bladder 1. During the manufacturing process the insulating layer 7 would preferably be cut out and folded in position with the bladder and melted or welded in place. Other shown methods in the art may be used to provide an insulating layer on the bladder. In the preferred embodiment of the pack the insulating layer is of a bubble wrap type material that has been glued to the bladder, although other insulating materials, such as, a silver coated plastics material, plastic foam sheet or polystyrene or other appropriate materials may be used. The insulating layer 7 has the purpose of maintaining the beverage cool or at a low temperature inside the bladder 1 as it lies between the user's body and the bladder 1.

In yet other forms of the pack of the present invention the whole of the bladder or merely the front panel of the bladder may have an insulating layer disposed about it.

The pack of the present invention may also have a reflective layer or area on it. In the preferred form the front panel has a reflective area 8. The reflective area is preferably a layer of reflective material adhered, welded or die cut and melted to the bladder during the manufacturing process. One such appropriate material would be a silver type plastic that is capable of reflecting sunlight and heat from the bladder. The reflective area would have the effect of assisting the maintenance of the temperature of the beverage within the bladder.

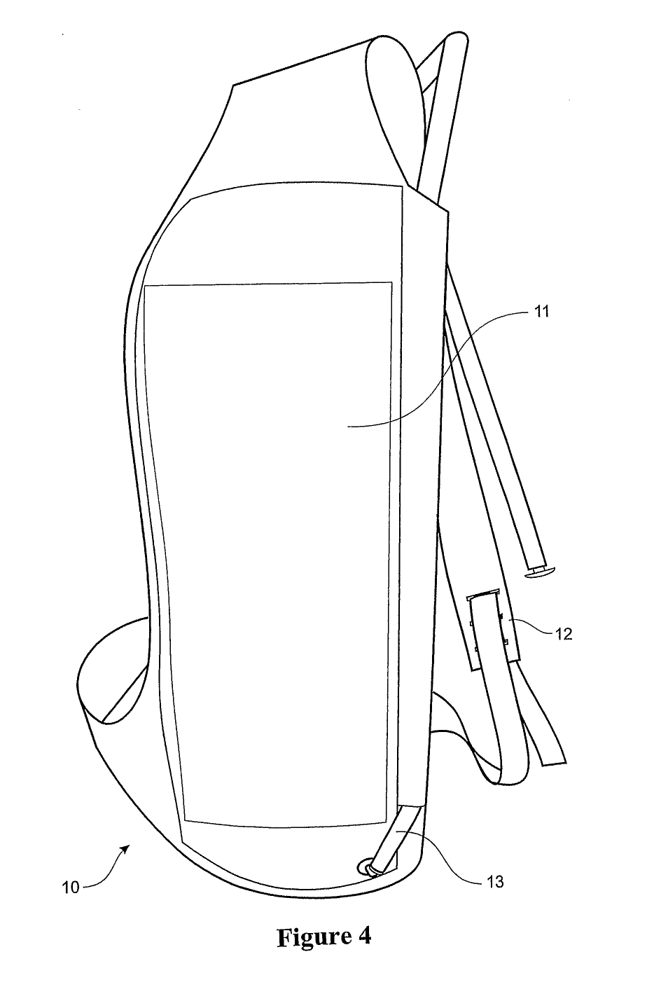

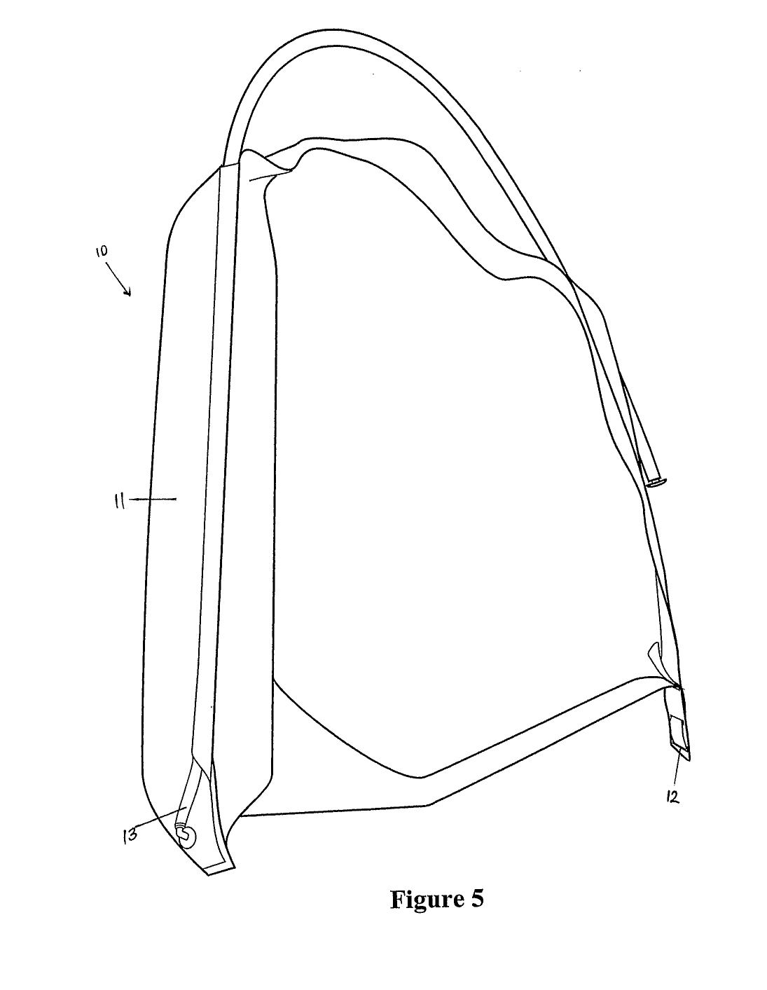

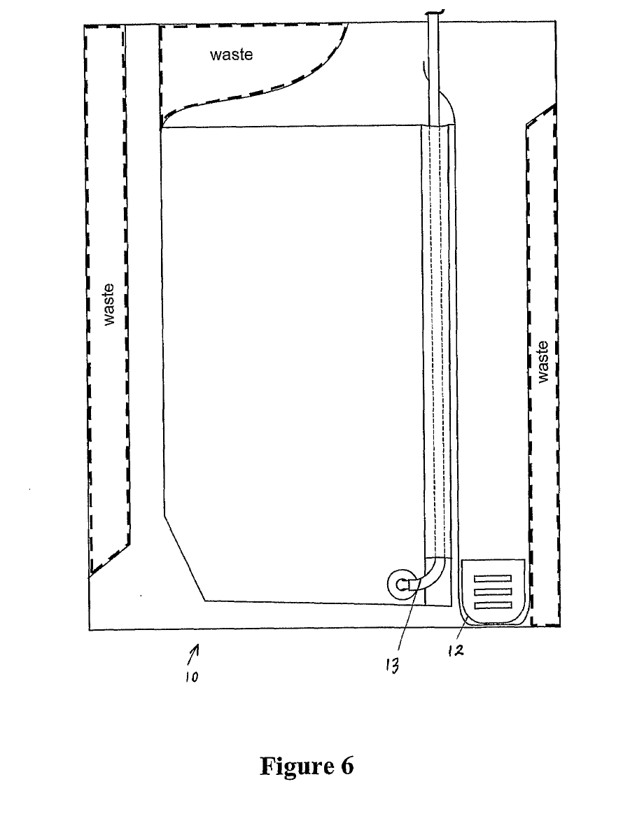

A second form of the pack of the present invention is shown in FIGS. 4 to 6. This pack 10 is comprised of a bladder 11 and a single integrated strap 12. The bladder and strap are preferably made from the same types of plastics material as that of the pack of FIG. 1. This pack may also have a reflective area and insulating layer as described above. The pack 10 also has a drinking tube 13 placed and made from the same materials as described above in relation to FIG. 1.

In other forms of the present invention the bladder may include a pouch or closeable envelope that may be used to retain various items. Such a pouch or closeable envelope would preferably be on the front of the pack. More preferably, a light stick or the like or advertising material may be placed within the pouch or envelope. In particular, a light stick might be provided within a pouch that at night could be snapped so that it highlights advertising on the bladder at night. Such a pouch or envelope may be formed with the bladder during manufacture or may be added to the bladder after manufacture.

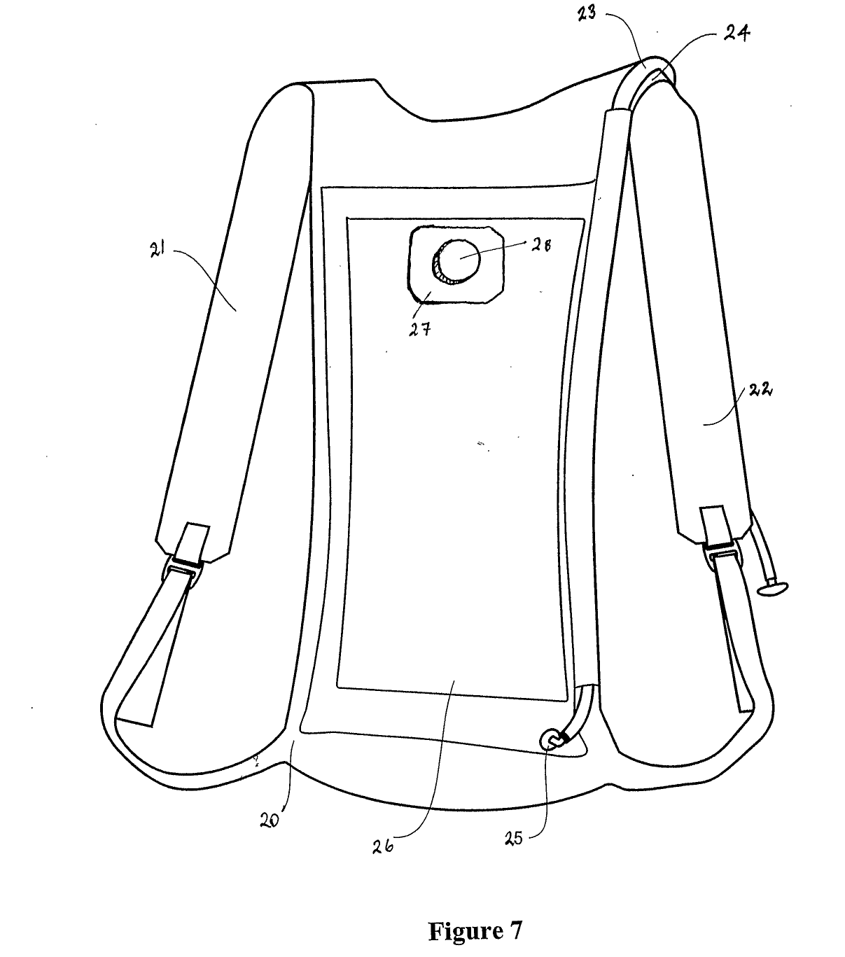

Further forms of packs of the present invention are shown in FIGS. 7 to 9. In this form the pack is refillable. These forms would be suitable for uses such as for trampers or walkers and would enable them to refill their packs as and when necessary. These forms of the pack would not be suitable for sale or use at concerts or the like as there would be a danger of tampering of the contents of the pack.

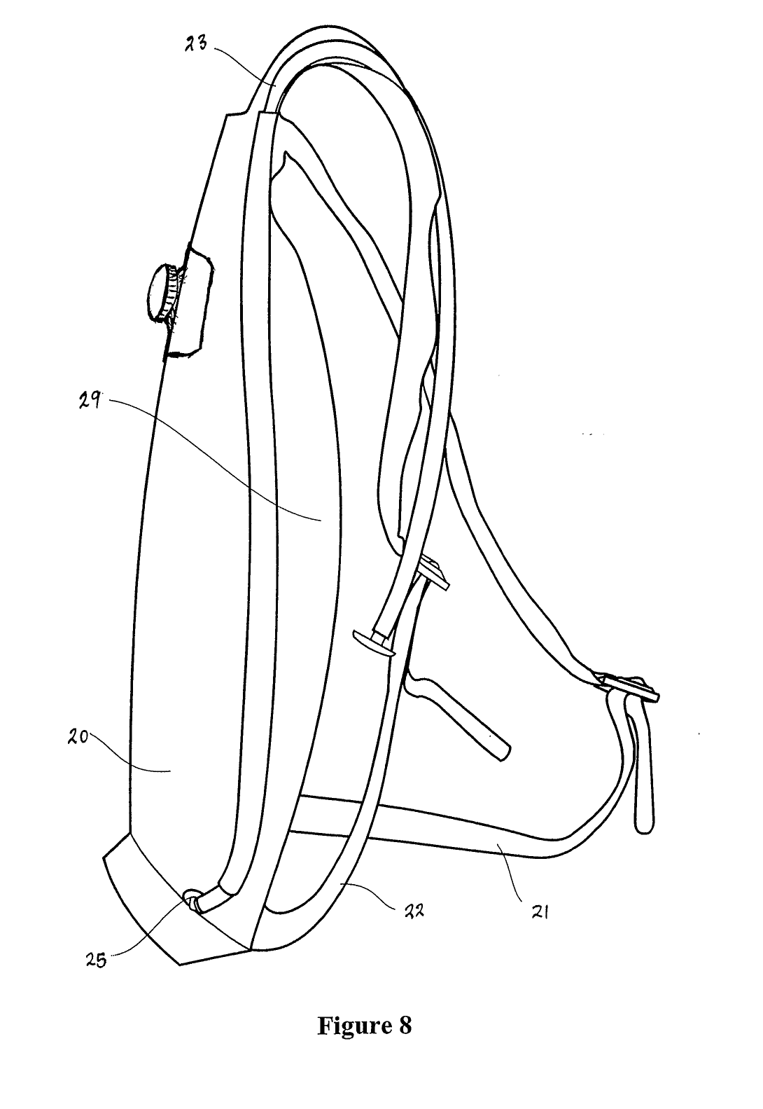

Referring to FIGS. 7 and 8 the pack is of a similar form to that described in relation to FIG. 1. The pack is a bladder 20 having two straps 21, 22 that are both preferably made from a plastics material. The pack has a drinking hose 23 attached and preferably enclosed along a substantial part of the packs length within or on the bladder 1 of the pack. The hose 23 preferably extends from the bottom edge of the bladder 20 through a sealed envelope 25, along the bladder's length and extends to the top 24 of one of the straps 22. In the preferred form of this pack the front panel has a reflective area 26 and insulating layer 29 as described above. An aperture is preferably formed through the reflective area 26 and bladder 20 that is reinforced and has a surround 27. The surround 27 is preferably capable of receiving a threaded (or other similar attachment or closure mechanism) cap or lid 28.

In use, when a user of the pack wants to refill the pack he or she merely needs to remove the cap 28 and through the aperture fill the bladder with liquid. Once full the user can thread the cap 28 over the aperture and tighten it so that liquid cannot leak through the aperture.

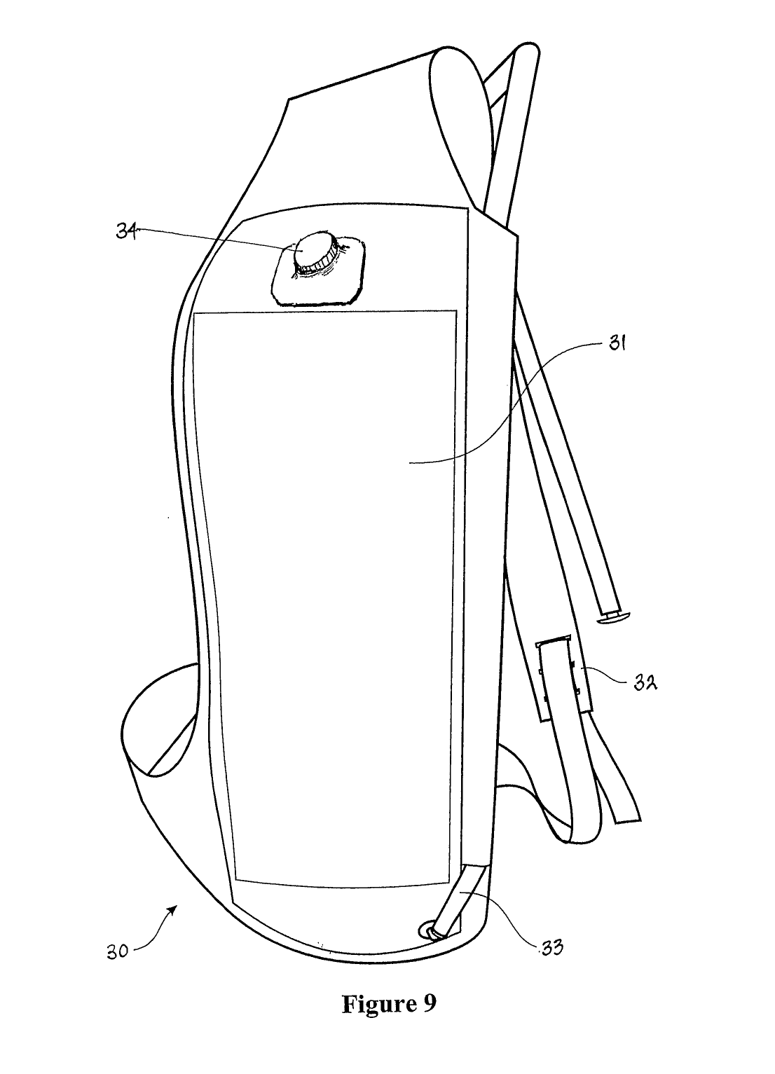

A fourth form of the pack of the present invention is shown in FIG. 9. In this form the pack 30 is a bladder 31 and a single integrated strap 32. The bladder 31 and strap 32 are preferably made from the same types of plastics material as that of the pack of FIG. 1. This pack may also have a reflective area and insulating layer as described above. The pack 30 also has a drinking tube 33 placed and made from the same materials as described above in relation to FIG. 1. The pack 30 in the preferred form also has an aperture and cap 34 that can be used to refill the bladder 31.

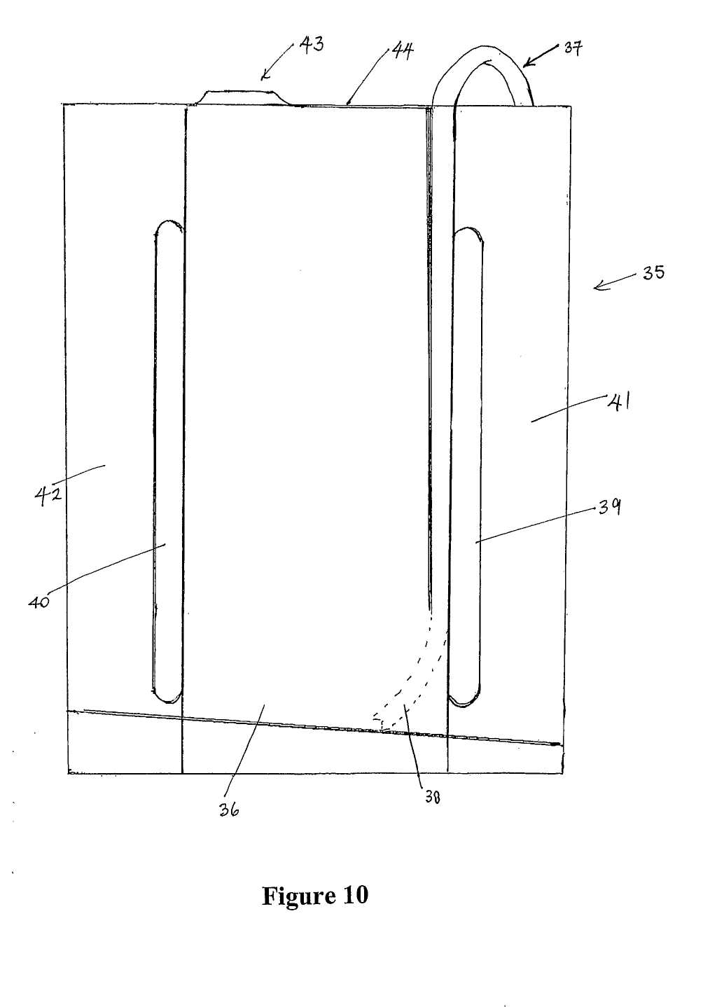

A fifth form of the pack 35 of the present invention is shown in FIG. 10 in stencil form. In this form the pack may be refillable or non-refillable. It is preferred that it is disposable and of a similar make up to the varying embodiments as described above. For example, this pack 35 is made from similar materials to those described above and may have an insulation layer and/or pouch as described above.

The pack 35 as shown in FIG. 10 has a bladder 36 and hose 37. The hose 37 is preferably embedded from the top edge of the bladder along the length of the bladder. It is preferred that the hose 37 is heat sealed to the bladder and the distal end of the hose 38 resides at the bottom of the bladder within the beverage to be held in the bladder. Substantially rectangular cut out areas 39, 40 are cut from the bladder of the present invention, preferably using heat welding to fold the straps such that the integral arm straps 41, 42 are formed. Therefore as the pack 37 is made from a pliable or flexible material, such as thin plastic, a user can place their arms through the cut out areas 39, 40, enabling the user to place the pack on their back, for example. In this form the pack 35 will be less costly as there is less waste material removed from the pack structure and more simple to manufacture.

If the pack is to be refillable it may include a zip-lock closure mechanism 43, for example along the top edge 44 of the bladder 36, or merely along a portion of the top edge.

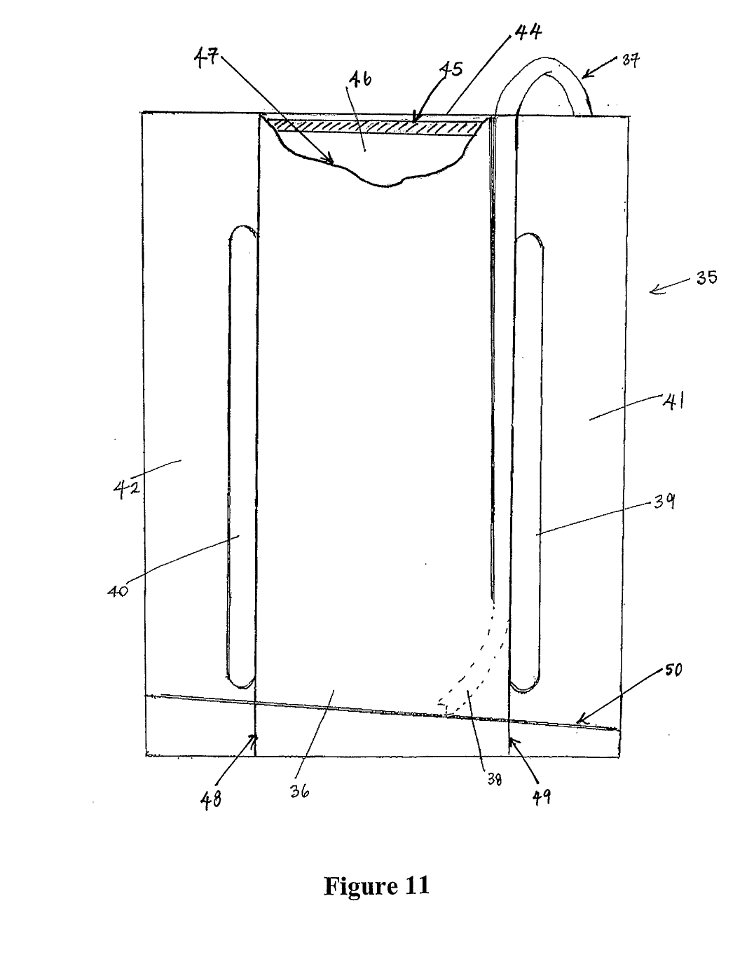

In a further form of the pack of the present invention where the pack has the purpose of being filled once and then disposed of, the top edge might include a tacky adhesive strip, that can be closed, sealing the bladder, after filling, but prevent reopening and refilling. FIG. 11 is an illustration of the stencil of a sixth form of the beverage pack of the present invention where the pack of FIG. 10 has a tacky adhesive strip 45 instead of a zip-lock closure mechanism. In FIG. 11 the adhesive strip 45 is shown extending along the top and entire width of the bladder 36 on one inner side or layer 46 of the bladder. The other side or layer 47 of the bladder is shown partially cut-away. The strip 45 would initially have a plastic covering, similar to that known for postage packages, where the plastic covering is removed to expose the adhesive strip 45. The two layers can then be stuck together to create a seal along the edge of the bladder. In use, a user can fill the bladder with their preferred beverage and close the top edge by removing a protective plastic strip exposing a tacky adhesive strip.

In other forms the adhesive strip may only extend along a portion of the top edge 44, where the rest of the edge is welded. In yet other forms one layer of the bladder may have an edge that extends out beyond the other layer such that the extended edge may be folded down over the adhesive strip to seal the bladder.

1. A beverage pack comprising:
a pliable bladder capable of storage of a liquid beverage,
at least one strap integrally formed with said bladder,
a hose capable of accessing said liquid beverage in said bladder and being sealed with said bladder.

2. A beverage pack according to claim 1 wherein said hose is fixed substantially along its length to said bladder.

3. A beverage pack according to claim 1 wherein said hose is plastic welded to said bladder.

4. A beverage pack according to claim 1 wherein said bladder has at least an area of insulation at least on one side of said bladder.

5. A beverage pack according to claim 1 wherein said bladder has a reflective area on at least one area of said bladder.

6. A beverage pack according to claim 4 wherein said insulation is a layer of bubble wrap attached to said bladder.

7. A beverage pack according to claim 5 wherein said reflective area is a reflective panel made from a reflective material.

8. A beverage pack according to claim 5 wherein said reflective panel is disposed on the front of said bladder.

9. A beverage pack according to claim 1 wherein said bladder includes an integral aperture and a closure over said aperture to enable filling of said bladder.

10. A beverage pack according to claim 1 wherein said bladder includes an aperture that is capable of being closed by one of a zip type mechanism or an adhesive strip.

11. A method of making a beverage pack including the steps of:
cutting out a bladder and at least one strap from a single folded rectangle of plastic,
welding a substantially rectangular bladder and at least one elongated strap,
folding said strap into a correct position to enable extending of said strap from said bladder over at least one of a users shoulder in use, and
welding said strap in said position.

12. A method of making a beverage pack according to claim 11 wherein said method includes the step of welding a layer of insulation to said bladder.

13. A method of making a beverage pack according to claim 11 wherein said method includes the step of welding a layer of reflective material to said bladder.

14. A method of making a beverage pack according to claim 11 wherein said method includes the steps of welding a hose connector to said bladder and imbedding and welding a hose along the side of said bladder.

15. A method of making a beverage pack according to claim 11 wherein said method includes imbedding a strap adjuster in said strap to allow the length of said strap to be adjusted.

16-17. (canceled)

18. A beverage pack according to claim 1 wherein said pack is disposable and non-refillable.

19. A beverage pack according to claim 1, said beverage pack made by the steps of:
cutting out a bladder and at least one strap from a single folded rectangle of plastic,
welding a substantially rectangular bladder and at least one elongated strap,
folding said strap into a correct position to enable extending of said strap from said bladder, and
welding said strap in said position.

20. A beverage pack according to claim 1, containing a beverage.

21. A beverage retained in a beverage pack as claimed in claim 1.

22. A beverage pack according to claim 7 wherein said reflective panel is disposed on the front of said bladder.

23. A beverage pack according to claim 12, containing a beverage.

24. A beverage retained in a beverage pack as claimed in claim 12.

25. A beverage pack according to claim 13, containing a beverage.

26. A beverage retained in a beverage pack as claimed in claim 13.

27. A beverage pack comprising a pliable bladder capable of storage of a liquid beverage and at least one strap integral with said bladder, said beverage pack made by the steps of:
cutting out a bladder and at least one strap from a single folded rectangle of plastic,
welding a substantially rectangular bladder and at least one elongated strap,
folding said strap into a correct position to enable extending of said strap from said bladder, and
welding said strap in said position.
